(19) United States
(12) Patent Application Publication
(10) Pub. No.: US 2007/0072955 A1
(43) Pub. Date: Mar. 29, 2007

(54) Negative dye-containing curable composition, color filter and method of producing the same

(75) Inventors: Toru Fujimori, Shizuoka-ken (JP); Akira Hibino, Kanagawa (JP); Nobuo Seto, Kanagawa (JP); Yoshiharu Yabuki, Kanagawa (JP); Yuki Mizukawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/527,553

(22) Filed: Sep. 27, 2006

(30) Foreign Application Priority Data
Sep. 29, 2005 (JP) 2005-285551

(51) Int. Cl. B29C 71/04

(52) U.S. Cl. 522/71

(57) ABSTRACT

A negative dye-containing curable composition, comprising: (A) an organic solvent-soluble dye, (B) a photopolymerization initiator, (C) a radical-polymerizable monomer, and (D) an organic solvent, wherein the composition contains further comprises (X) an inorganic metal salt that is different from the organic solvent-soluble dye (A), and the content of the inorganic metal salt (X) is 0.1 mass % or less with respect to the total solid content of the composition is provided.

### CROSS-REFERENCE TO RELATED APPLICATION

This application claims priority under 35 USC 119 from Japanese Patent Application No. 2005-285551, the disclosure of which is incorporated by reference herein.

### BACKGROUND OF THE INVENTION

1. Field of the Invention

The present invention relates to a negative dye-containing curable composition suitable for forming colored images constituting color filters used for liquid crystal display elements (CVD), solid state image pick-up elements (for example, CCD and CMOS) and the like, also to a color filter using the negative dye-containing curable composition and, further, to a method of producing the color filter.

2. Description of the Related Art

As methods of producing a color filter used for liquid crystal display elements and solid state image pick-up elements, a dyeing method, a printing method, an electrodepositing method and a pigment dispersion method are known.

In the pigment dispersion method, the color filter is produced by a photolithographic method using a colored radiation-sensitive composition prepared by dispersing a pigment in any one of various types of photosensitive compositions. The color filter produced by this method is stable with respect to light, heat and the like since the pigment is used. A high positional accuracy can be obtained in this method since patterning is performed by the photolithographic method and, accordingly, this method has widely been used as a method suitable for producing the color filter for a large screen and high fineness color display.

In a case in which the color filter is produced by the pigment dispersion method, the radiation-sensitive composition is first coated on a glass substrate by using, for example, a spin coater or a roll coater and, then, dried, to thereby form a coating film. Then, colored pixels are obtained by pattern-exposing and developing the thus-formed coating film. The color filter can be obtained by repeating such operation as described above by the number of different colors.

As for the pigment dispersion method, a method which uses a negative photosensitive composition comprising an alkali-soluble resin together with a photopolymerizable monomer and a photopolymerization initiator is proposed in each of, for example, JP-A Nos. 2-181704, 2-199403, 5-273411 and 7-140654.

On the other hand, the color filter for the solid state image pick-up element has been required to be finer in recent years. However, it is difficult to further improve resolution of the color filter according to the conventional pigment dispersion system. This is because the pigment dispersion method is not suitable for an application requiring a fine patterning such as the solid state image pick-up element since color unevenness occurs due to coarse pigment particles.

In order to solve the aforementioned problems, a technique using a dye instead of the pigment is proposed in JP-A No. 6-75375. However, a problem arises that a dye-containing curable composition is generally inferior to a pigment-containing curable composition in various types of properties such as light fastness, heat resistance, solubility and coating evenness. Further, particularly in a case in which the dye-containing curable composition is used in forming the color filter for the solid state image pick-up element, since a film thickness as thin as 1.5 μm or less is required, it is necessary to incorporate a large amount of dye into the curable composition and such incorporation causes other problems of an insufficient adhesion with the substrate, an insufficient curing and bleaching of the dye in an exposed portion and, then, it becomes extremely difficult to attain good pattern forming properties.

Further, in a figment based resist, inorganic metallic salts contained in the resist results in various problems (see, for example, JP-A No. 2001-166124).

### SUMMARY OF THE INVENTION

In view of the above, the present invention has been devised in order to address problems in the existing art and provides a curable composition capable of using dyes. Specifically, the present invention provides a negative dye-containing curable composition which is superior in preservation stability and has good light fastness, and a color filter using the same. Also, the present invention provides a method for producing a color filter, which can produce a superior color filter with a high cost performance, especially a color filter for solid state image pick-up elements.

A first aspect of the invention is a negative dye-containing curable composition, comprising (A) an organic solvent-soluble dye, (B) a photopolymerization initiator, (C) a radical-polymerizable monomer, and (D) an organic solvent, wherein the composition further comprises (X) an inorganic metal salt that is different from the organic solvent-soluble dye (A), and the content of the inorganic metal salt (X) is 0.1 mass % or less with respect to the total solid content of the composition.

A second aspect of the invention is the negative dye-containing curable composition according to the first aspect, wherein the content of the inorganic metal salt (X) is 0.01 mass % or less with respect to the total solid content of the composition.

A third aspect of the invention is the negative dye-containing curable composition according to the first or second aspect, further comprising (E) a binder resin.

A fourth aspect of the invention is the negative dye-containing curable composition according to any of the first to third aspects, wherein the radical-polymerizable monomer (C) comprises at least one additionally polymerizable ethylenic double bond and has a boiling point of 100° C. or above at atmospheric pressure.

A fifth aspect of the invention is the negative dye-containing curable composition according to the fourth aspect, wherein the radical-polymerizable monomer (C) is a multifunctional (metha)acryl compound.

A sixth aspect of the invention is the negative dye-containing curable composition according to the third aspect, wherein the binder resin is an alkali-soluble resin.

A seventh aspect of the invention is the negative dye-containing curable composition according to any of the first to sixth aspects, wherein the organic soivent-soluble dye is a mixture of two or more dyes whose respective light absorption properties are different.

An eighth aspect of the invention is the negative dye-containing curable composition according to any of the first to seventh aspects, wherein the photopolymerization initiator (B) is at least one compound selected from the group consisting of actively halogenized compounds such as diazole compounds and triazine compounds; 3-aryl-substituted coumarin compounds; lophine dimers; benzophenone compounds; acetophenone compounds and derivatives thereof; cyclopentadiene-benzene-iron complexes and salts thereof; and oxime compounds.

A ninth aspect of the invention is the negative dye-containing curable composition according to the eighth aspect, wherein at least one of the photopolymerization initiators (B) is a triazine or an oxime photopolymerization initiator.

A tenth aspect of the invention is a color filter, produced by using a negative dye-containing curable composition according to any of the first to ninth aspects.

An eleventh aspect of the invention is a method of producing a color filter, comprising: applying a negative dye-containing curable according to any of the first to ninth aspects onto a substrate to form a radiation sensitive composition layer; exposing the applied layer through a mask; and developing the layer to form a negative colored pattern.

A twelfth aspect of the invention is the method of producing a color filter according to the eleventh aspect, wherein the method further comprises curing the patterned image by heating and/or exposing.

A thirteenth aspect of the invention is the method of producing a color filter according to the eleventh aspect, wherein pattern forming is repeated according to the number of colors.

A fourteenth aspect of the invention is the method of producing a color filter according to the twelfth aspect, wherein curing is repeated according to the number of colors.

### DETAILED DESCRIPTION OF THE INVENTION

Hereinafter, a negative dye-containing curable composition, a color filter to be producing by using the negative dye-containing curable composition and a method of producing the color filter will be described in detail.

Negative Dye-Containing Curable Composition

In an embodiment of the present invention, a negative dye-containing curable composition comprises (A) an organic solvent-soluble dye, (B) a photopolymerization initiator, (C) a radical-polymerizable monomer, and (D) an organic solvent, wherein the composition further comprises (X) an inorganic metal salt that is different from the organic solvent-soluble dye (A), and the content of the inorganic metal salt (X) is 0.1 mass % or less with respect to the total solid content of the composition. The negative dye-containing curable composition may further comprise other components such as (E) a binder resin, a crosslinking agent, and the like.

In an embodiment of the present invention, when the content of the inorganic metal salt (X) is set to 0.1 mass % or less with respect to the total solid content of the composition, preservation stability of resist solutions (the negative dye-containing curable composition) can be improved, and light fastness thereof can be further enhanced.

(A) Organic Solvent-Soluble Dye

The organic solvent-soluble dye (A) is not particularly limited, so long as it is soluble in an organic solvent. For example, a conventionally known dye for color filter may be used. Specific examples of such organic solvent-soluble dyes include dyes as described in JP-A Nos. 64-90403, 64-91102, 1-94301 and 6-11614; Japanese Patent No. 2592207; U.S. Pat. Nos. 4,808,501, 5,667,920 and 5,059,500; and JP-A Nos. 5-333207, 6-35183, 6-51115 and 6-194828. Preferred examples of the organic solvent-soluble dye include, from the viewpoint of chemical structure, dyes of a triphenylmethane type, an anthraquinone type, a benzylidene type, an oxonol type, a cyanine type, a phenothiazine type, a pyrrolopyrazole azomethine type, a xanthene type, a phthalocyanine type, a benzopyran type, an indigo type and the like. The organic solvent-soluble dyes are, particularly preferably, dyes of a pyrazole azo type, an anilinoazo type, a pyrazolotriazole azo type, a pyridone azo type, an anthraquinone type and an anthrapyridone type.

Further, in a case of a resist system in which development is performed in water or an alkaline solution, an acid dye or a derivative thereof may favorably be used from the viewpoint of completely removing the binder and/or the dye by the development. Further, at least one of a direct dye, a basic dye, a mordant dye, an acid mordant dye, an azoic dye, a disperse dye, an oil-soluble dye, a dye for food and derivatives thereof may also be usefully used.

Acid Dye

The acid dye will be described below. The acid dye is not particularly limited, so long as it is a dye having an acidic group such as, for example, a sulfonic acid, a carboxylic acid, or a phenolic hydroxyl group. However, it is preferable to select the acid dye by taking into consideration all of required properties, such as solubility against an organic solvent or a developer, formability of a salt with a basic compound, light absorbance, an interaction with any one of other components in the curable composition, light fastness and heat resistance.

Specific examples of such acid dyes are described below, but the invention is not restricted to these examples:

Acid Alizarin Violet N; Acid Black 1, 2, 24, 48; Acid Blue 1, 7, 9, 15, 18, 23, 25, 27, 29, 40, 42, 45, 51, 62, 70, 74, 80, 83, 86, 87, 90, 92, 96, 103, 112, 113, 120, 129, 138, 147, 150, 158, 171, 182, 192, 210, 242, 243, 256, 259, 267, 278, 280, 285, 290, 296, 315, 324:1, 335, 340; Acid Chrome violet K; Acid Fuchsin; Acid Green 1, 3, 5, 9, 16, 25, 27, 50, 58, 63, 65, 80, 104, 105, 106, 109; Acid Orange 6, 7, 8, 10, 12, 26, 50, 51, 52, 56, 62, 63, 64, 74, 75, 94, 95, 107, 108, 169, 173;

Acid Red 1, 4, 8, 14, 17, 18, 26, 27, 29, 31, 34, 35, 37, 42, 44, 50, 51, 52, 57, 66, 73, 80, 87, 88, 91, 92, 94, 97, 103, 111, 114, 129, 133, 134, 138, 143, 145, 150, 151, 158, 176, 182, 183, 195, 198, 206, 211, 215, 216, 217, 227, 228, 249, 252, 257, 258, 260, 261, 266, 268, 270, 274, 277, 280, 281, 308, 312, 315, 316, 339, 341, 345, 346, 349, 382, 383, 394, 401, 412, 417, 418, 422, 426; Acid Violet 6B, 7, 9, 17, 19; Acid Yellow 1, 3, 7, 9, 11, 17, 23, 25, 29, 34, 36, 38, 40, 42, 54, 65, 72, 73, 76, 79, 98, 99, 111, 112, 113, 114, 116, 119, 123, 128, 134, 135, 138, 139, 140, 144, 150, 155, 157, 160, 161, 163, 168, 169, 172, 177, 178, 179, 184, 190, 193, 196, 197, 199, 202, 203, 204, 205, 207, 212, 214, 220, 221, 228, 230, 232, 235, 238, 240, 242, 243, 251;

Direct Yellow 2, 33, 34, 35, 38, 39, 43, 47, 50, 54, 58, 68, 69, 70, 71, 86, 93, 94, 95, 98, 102, 108, 109, 129, 136, 138, 141; Direct Orange 34, 39, 41, 46, 50, 52, 56, 57, 61, 64, 65, 68, 70, 96, 97, 106, 107; Direct Red 79, 82, 83, 84, 91, 92, 96, 97, 98, 99, 105, 106, 107, 172, 173, 176, 177, 179, 181, 182, 184, 204, 207, 211, 213, 218, 220, 221, 222, 232, 233, 234, 241, 243, 246, 250; Direct Violet 47, 52, 54, 59, 60, 65, 66,79, 80, 81, 82, 84, 89, 90, 93, 95, 96, 103, 104;

Direct Blue 57, 77, 80, 81, 84, 85, 86, 90, 93, 94, 95, 97, 98, 99, 100, 101, 106, 107, 108, 109, 113, 114, 115, 117, 119, 137, 149, 150, 153, 155, 156, 158, 159, 160, 161, 162, 163, 164, 166, 167, 170, 171, 172, 173, 188, 189, 190, 192, 193, 194, 196, 198, 199, 200, 207, 209, 210, 212, 213, 214, 222, 228, 229, 237, 238, 242, 243, 244, 245, 247, 248, 250, 251, 252, 256, 257, 259, 260, 268, 274, 275, 293; Direct Green 25, 27, 31, 32, 34, 37, 63, 65, 66, 67, 68, 69, 72, 77, 79, 82; Mordant Yellow 5, 8, 10, 16, 20, 26, 30, 31, 33, 42, 43, 45, 50, 56, 61, 62, 65; Mordant Orange 3, 4, 5, 8, 12, 13, 14, 20, 21, 23, 24, 28, 29, 32, 34, 35, 36, 37, 42, 43, 47, 48;

Mordant Red 1, 2, 3, 4, 9, 11, 12, 14, 17, 18, 19, 22, 23, 24, 25, 26, 30, 32, 33, 36, 37, 38, 39, 41, 43, 45, 46, 48, 53, 56, 63, 71, 74, 85, 86, 88, 90, 94, 95; Mordant violet 2, 4, 5, 7, 14, 22, 24, 30, 31, 32, 37, 40, 41, 44, 45, 47, 48, 53, 58; Mordant Blue 2, 3, 7, 8, 9, 12, 13, 15, 16, 19, 20, 21, 22, 23, 24, 26, 30, 31, 32, 39, 40, 41, 43, 44, 48, 49, 53, 61, 74, 77, 83, 84; Mordant Green 1, 3, 4, 5, 10, 15, 19, 26, 29, 33, 34, 35, 41, 43, 53; Food Yellow 3; and derivatives of theses dyes.

Among the acid dyes described above, it is preferably the following dyes and derivatives thereof:

Acid Black 24; Acid Blue 23, 25, 29, 62, 80, 86, 87, 92, 138, 158, 182, 243, 324:1; Acid Orange 8, 51, 56, 63, 74; Acid Red 1, 4, 8, 34, 37, 42, 52, 57, 80, 97, 114, 143, 145, 151, 183, 217, 249; Acid Violet 7; Acid Yellow 17, 25, 29, 34, 42, 72, 76, 99, 111, 112, 114, 116, 134, 155, 169, 172, 184, 220, 228, 230, 232, 243; Acid Green 25; derivatives of these dyes.

In addition to the above dyes, acid dyes such as azo type, xanthene type, phthalocyanine type, and the like are preferable, and acid dyes such as C.I. solvent Blue 44, 38; C.I. Solvent Orange 45; Rhodamine B; Rhodamine 110; 3-[(5-chloro-2-phenoxyphenyl)hydrazono]-3,4-dihydro-4-oxo-5-[(phenylsulfonyl)amino]-2,7-Naphthalene disulfonic acid; and derivatives thereof are preferably used.

As for the derivatives of acid dyes, an inorganic salt of the acid dye having an acidic group such as a sulfonic acid and a carboxylic acid, a salt of the acid dye with a nitrogen-containing compound, and a sulfonamide of the acid dye and the like may be used. The derivatives are not particularly limited, so long as they are soluble in a solution of the curable composition. However, the acid dye is selected by taking into consideration all of required properties, such as solubility against an organic solvent or a developer, light absorbance, an interaction with any other components in the curable composition, light fastness and heat resistance.

The salt of the acid dye with the nitrogen-containing compound will be described below. Forming a salt of the acid dye and the nitrogen-containing compound may be effective for improving solubility (imparting solubility in an organic solvent) of the acid dye, heat resistance and light fastness.

The nitrogen-containing compound that forms a salt with the acid dye, and the nitrogen-containing compound that forms an amide bond with the acid dye will be described below.

The nitrogen-containing compound is selected taking into consideration all of the required properties such as solubility of the salt or the amide compound in the organic solvent or the developer, salt forming ability, light absorbance and a color value of the dye, an interaction between the nitrogen-containing compound and any other components in the curable composition, and heat resistance and light fastness as a coloring agent. A molecular weight of the nitrogen-containing compound is preferably as small as possible when the compound is selected considering only the light absorbance and color value. The molecular weight is preferably 300 or less, more preferably 280 or less and, particularly preferably, 250 or less.

A molar ratio (hereinafter, referred to as “n”) of the nitrogen-containing compound to the acid dye in the salt of the acid dye and nitrogen-containing compound will be described below. The molar ratio n denotes a ratio of an acid dye molecule to an amine compound as a counter ion. The molar ratio n may be freely selected depending on a salt forming conditions of the acid dye and the amine compound. Specifically, n is a value satisfying the relation of 0<n≦5 of the number of the functional groups in the acid of the acid dye in most practical cases, and may be selected considering all the required properties such as solubility in the organic solvent or the developer, salt forming ability, light absorbance, an interaction with any other components in the curable composition, light fastness and heat resistance. When n is selected from the viewpoint of only the light absorbance, n preferably satisfies the relation of 0<n≦4.5, more preferably 0<n≦4 and, particularly preferably, 0<n≦3.5.

Since the acid dye is prepared by incorporating an acid group into a structure thereof, it can be converted into a non-acid dye by changing a substituent thereof.

The acid dye may favorably act at the time of an alkaline development but may sometimes be over-developed, and non-acid dyes may be used. As the non-acid dyes, dyes having no acidic group in the acid dyes mentioned above may be used.

For the dyes, in order to constitute the complementary colors of yellow, magenta, and cyan, it is possible to use each of single dyes. However, in the case of constituting the primary colors of red, green and blue, then combinations of two or more dyes are used. It is preferable that primary colors are made up using combinations of two or more dyes.

Further, the organic solvent-soluble dyes comprise preferably a mixture of two or more of dyes in which light absorbency properties are different each other. By two or more of the dyes in which light absorbency properties are different each other, color toning may be easily obtained depending on the purposes. Examples of such combination include a combination of magenta and yellow, a combination of cyan and yellow, a combination of cyan and violet, and the like. Further, a combination of two magentas and an yellow, a combination of a magenta and two yellows, a combination of two cyans and an yellow, a combination of a cyan and two yellows, a combination of two cyans and a violet, a combination of a cyan and two violets, and the like.

Concentration of the organic solvent-soluble dyes will be explained hereinafter. The concentration of the organic solvent-soluble dyes in the solid content of the negative dye-containing curable composition depends on the dyes, and from the viewpoint of balancing between color reproducibility and film hardening property, preferably 0.5˜80 mass %, and more preferably, 10˜60 mass %. Further, In case of toning by mixing two or more of dyes, amount of the dyes which are added in very small quantities is preferably at least 10% or more of the total amount 100% of the dyes.

(B) Photopolymerization Initiator

Next, the photopolymerization initiator (B) will be described. The photopolymerization initiator is contained together with a radical-polymerizable monomer (C) which will be explained later in the negative dye-containing curable composition. The photopolymerization initiator is not particularly limited, so long as it can polymerize the radical-polymerizable monomer. The photopolymerization initiator is preferably selected from the viewpoint of its properties, polymerization initiation efficiency, absorbing wavelength, availability, cost and the like.

Examples of such photopolymerization initiators include at least one active halogen compound selected from halomethyl oxadiazole compounds and halomethyl-s-triazine compounds; 3-aryl substituted coumarin compounds; lophine dimers; benzophenone compounds; acetophenone compounds and derivatives thereof; cyclopentadiene-benzene-iron complexes and salts thereof; and oxime compounds.

Examples of the active halogen compound as the halomethyloxadiazole compound include 2-halomethyl-5-vinyl-1,3,4-oxadiazole compound described in JP-B No. 57-6096, 2-trichloromethyl-5-styryl-1,3,4-oxadiazole, 2-trichloromethyl-5-(p-cyanostyryl)-1,3,4-oxadiazole and 2-trichloromethyl-5-(p-methoxystyryl)-1,3,4-oxadiazole.

Examples of the active halogen compound as the halomethyl-s-triazine compound include a vinyl-halomethyl-s-triazine compound described in JP-B No. 59-1281, and a 2-(naphtho-1-yl)-4,6-bis-halomethyl-s-triazine compound and a 4-(p-aminophenyl)-2,6-dihalomethyl-s-triazine compound described in JP-A No.

Specific examples thereof include 2,4-bis(trichloromethyl)-6-p-methoxystyryl-s-triazine, 2,6-bis(trichloromethyl)-4-(3,4-methylenedioxyphenyl)-1,3,5-triazine, 2,6-bis(trichloromethyl)-4-(4-methoxyphenyl)-1,3,5-triazine, 2,4-bis(trichloromethyl)-6-(1-p-dimethylaminophenyl-1,3-butadienyl)-s-triazine, 2-trichloromethyl-4-amino-6-p-methoxystyryl-s-triazine, 2-(naphtho-1-yl)-4,6-bistrichloromethyl-s-triazine, 2-(4-methoxy-naphto-1-yl)-4,6-bistrichloromethyl-s-triazine, 2-(4-ethoxy-naphtho-1-yl)-4,6-bistrichloromethyl-s-triazine, 2-(4-butoxy-naphtho-1-yl)-4,6-bistrichloromethyl-s-triazine, 2-(4-(2-methoxyethyl)-naphto-1-yl)-4,6-bistrichloromethyl-s-triazine,

2-(4-(2-ethoxyethyl)-naphtho-1-yl)-4,6-bistrichloromethyl-s-triazine, 2-(4-(2-butoxyethyl)-naphtho-1-yl)-4,6-bistrichloromethyl-s-triazine, 2-(2-methoxy-naphtho-1-yl)-4,6-bistrichloromethyl-s-triazine, 2-(6-methoxy-5-methyl-naphtho-2-yl)-4,6-bistrichloromethyl-s-triazine, 2-(6-methoxy-naphtho-2-yl)-4,6-bistrichloromethyl-s-triazine, 2-(5-methoxy-naphtho-1-yl)-4,6-bistrichloromethyl-s-triazine, 2-(4,7-dimethoxy-naphtho-1-yl)-4,6-bistrichloromethyl-s-triazine, 2-(6-ethoxy-naphtho-2-yl)-4,6-bistrichloromethyl-s-triazine, 2-(4,5-dimethoxy-naphtho-1-yl)-4,6-bistrichloromethyl-s-triazine,

4-(p-N,N-di(ethoxycarbonylmethyl)aminophenyl)-2,6-di(trichloromethyl)-s-triazine, 4-(o-methyl-p-N,N-di(ethoxycarbonylmethyl)aminophenyl)-2,6-di(trichloromethyl)-s-triazine, 4-(p-N,N-di(chloroethyl)aminophenyl)-2,6-di(trichloromethyl)-s-triazine, 4-(o-methyl-p-N,N-di (chloroethyl)aminophenyl)-2,6-di(trichloromethyl)-s-triazine, 4-(p-N-chloroethylaminophenyl)-2,6-di(trichloromethyl)-s-triazine, 4-(p-N-ethoxycabonylmethylaminophenyl)-2,6-di(trichloromethyl)-s-triazine, 4-(p-N,N-di(phenyl)aminophenyl)-2,6-di(trichloromethyl)-s-triazine, 4-(p-N-chloroethylcarbonylaminophenyl)-2,6-di(trichloromethyl)-s-triazine,

4-(p-N-(p-methoxyphenyl)carbonylaminophenyl)-2,6-di(trichloromethyl)-s-triazine, 4-(m-N,N-di(ethoxycarbonylmethyl)aminophenyl)-2,6-di(trichloromethyl)-s-triazine, 4-(m-bromo-p-N,N-di(ethoxycarbonylmethyl)aminophenyl)-2,6-di(trichloromethyl)-s-triazine, 4-(m-chloro-p-N,N-di(ethoxycarbonylmethyl)aminophenyl)-2,6-di(trichloromethyl)-s-triazine, 4-(m-fluoro-p-N,N-di(ethoxycarbonylmethyl)aminophenyl)-2,6-di(trichloromethyl)-s-triazine, 4-(o-bromo-p-N,N-di(ethoxycarbonylmethyl)aminophenyl)-2,6-di(trichloromethyl)-s-triazine, 4-(o-chloro-p-N,N-di(ethoxycarbonylmethyl)aminophenyl)-2,6-di(trichloromethyl)-s-triazine,

4-(o-fluoro-p-N,N-di(ethoxycarbonylmethyl)aminophenyl-2,6-di(trichloromethyl)-s-triazine, 4-(o-bromo-p-N,N-di(chloroethyl)aminophenyl-2,6-di(trichloromethyl)-s-triazine, 4-(o-chloro-p-N,N-di(chloroethyl)aminophenyl)-2,6-di(trichloromethyl)-s-triazine, 4-(o-fluoro-p-N,N-di(chloroethyl)aminophenyl)-2,6-di(trichloromethyl)-s-triazine, 4-(m-bromo-p-N,N-di(chloroethyl)aminophenyl)-2,6-di(trichloromethyl)-s-triazine, 4-(m-chloro-p-N,N-di(chloroethyl)aminophenyl)-2,6-di(trichloromethyl)-s-triazine,

4-(m-fluoro-p-N,N-di(chloroethyl)aminophenyl)-2,6-di(trichloromethyl)-s-triazine, 4-(m-bromo-p-N-ethoxycarbonylmethylaminophenyl)-2,6-di(trichloromethyl)-s-triazine, 4-(m-chloro-p-N-ethoxycarbonylmethylaminophenyl)-2,6-di(trichloromethyl)-s-triazine, 4-(m-fluoro-p-N-ethoxycarbonylmethylaminophenyl)-2,6-di(trichloromethyl)-s-triazine, 4-(o-bromo-p-N-ethoxycarbonylmethylaminophenyl)-2,6-di(trichloromethyl)-s-triazine, 4-(o-chloro-p-N-ethoxycarbonylmethylaminophenyl)-2,6-di(trichloromethyl)-s-triazine,

4-(o-fluoro-p-N-ethoxycarbonylmethylaminophenyl)-2,6-di(trichloromethyl)-s-triazine, 4-(m-bromo-p-N-chloroethylaminophenyl)-2,6-di(trichloromethyl)-s-triazine, 4-(m-chloro-p-N-chloroethylaminophenyl)-2,6-di(trichloromethyl)-s-triazine, 4-(m-fluoro-p-N-chloroethylaminophenyl)-2,6-di(trichloromnethyl)-s-triazine, 4-(o-bromo-p-N-chloroethylaminophenyl)-2,6-di(trichlorornethyl)-s-triazine, 4-(o-chloro-p-N-chloroethylaminophenyl)-2,6-di(trichloromethyl)-s-triazine and 4-(o-fluoro-p-N-chloroethylaminophenyl)-2,6-di(trichloromethyl)-s-triazine.

Examples of other photopolymerization initiators which are usefully used and commercially available include TAZ-series manufactured by Midori Kagaku Co., Ltd. (for example, trade name: TAZ-107, TAZ-110, TAZ-104, TAZ-109, TAZ-140, TAZ-204, TAZ-113 and TAZ-123), T-series manufactured by PANCHIM Co. (for example, trade name: T-OMS, T-BMP, T-R and T-B), Irgacure series manufactured by Ciba Specialties Corp. (for example, trade name: Irgacure 651, Irgacure 184, Irgacure 500, Irgacure 1000, Irgacure 149, Irgacure 819 and Irgacure 261), Darocure series (for example, trade name: Darocure 1173), 4,4′-bis(diethylamino)-benzophenone, 2-(o-benzoyloxime)-1-[4-(phenylthio)phenyl]-1,2-octanedione, 1-(O-acetyloxime)-1-[9-ethyl-6-(2-methylbenzoyl)-9H-carbazole-3-yl]ethanone, 2-benzyl-2-dimethylamino-4-morphorinobutylophenone, 2,2-dimethoxy-2-phenylacetophenone,

2-(o-chlorophenyl)-4,5-diphenylimidazolyl dimer, 2-(o-fluorophenyl)-4,5-diphenylimidazolyl dimer, 2-(o-methoxyphenyl)-4,5-diphenylimidazolyl dimer, 2-(p-methoxyphenyl)-4,5-diphenylimidazolyl dimer, 2-(p-dimethoxyphenyl)-4,5-diphenylimidazolyl dimer, 2-(2,4-dimethoxyphenyl)-4,5-diphenylimidazolyl dimer, 2-(p-methylmercaptophenyl)-4,5-diphenylimidazolyl dimer and benzoin isopropyl ether.

As the oxime based photopolymerization initiators comprising oxim compounds, oxime based initiators described in, for example, JP-A No. 2000-80068, WO-02/100903A1, JP-A No. 2001-233842, and the like have been known.

Examples of the oxime compound include 2-(O-benzoyloxime)-1-[4-(phenylthio)phenyl]-1,2-butanedione, 2-(O-bezoyloxime)-1-[4-(phenylthio)phenyl]-1,2-pentanedione, 2-(O-benzoyloxime)-1-[4-(phenylthio)phenyl]-1,2-hexanedione, 2-(O-benzoyloxime)-1-[4-(phenylthio)phenyl]-1,2-pentanedione, 2-(O-benzoyloxTme)-1-[4-(phenylthio)phenyl]-1,2-octanedione, 2-(O-benzoyloxime)-1-[4-(methylphenylthio)phenyl]-1,2-butanedione, 2-(O-benzoyloxime)-1-[4-(ethylphenylthio)phenyl]-1,2-butanedione, 2-(O-benzoyloxime)-1-[4-(butylphenylthio)phenyl]-1,2-butanedione, 1-(O-acetyloxime)-1-[9-ethyl-6-(2-methylbenzoyl)-9H-carbazol-3-yl]ethanone, 1-(O-acetyloxime)-1-[9-methyl-6-(2-methylbenzoyl)-9H-carbazol-3-yl]ethanone, 1-(O-acetyloxime)-1-[9-propyl-6-(2-methylbenzoyl)-9H-carbazol-3-yl]ethanone, 1-(O-acetyloxime)-1-[9-ethyl-6-(2-methylbenzoyl)-9H-carbazol-3-yl]ethanone, 1-(O-acetyloxime)-1-[9-ethyl-6-(2-butylbenzoyl)-9H-carbazol-3-yl]ethanone, and the like, but the invention is not limited thereto.

These photopolymerization initiators may be used alone or two or more of these may be used in combination, but at least one of the photopolymerization initiators is preferably triazine based photopolymerization initiators or oxime based photopolymerization initiators, and more preferably oxime based photopolymerization initiators. Among these various kinds of photopolymerization initiators, 2-(o-benzoyloxime)-1-[4-(phenylthio)phenyl]-1,2-octanedione and 1-(O-acetyloxime)-1-[9-ethyl-6-(2-methylbenzoyl)-9H-carbazol-3-yl]ethanone each of which manufactured by Ciba Speciality Chemicals are preferred as the photopolymerzation initiator.

The photopolymerization initiator may be used in combination with a sensitizer and a photostabilizer.

Examples thereof include benzoin, benzoin methyl ether, 9-fluorenone, 2-chloro-9-fluorenone, 2-methyl-9-fluorenone, 9-anthrone, 2-bromo-9-anthrone, 2-ethyl-9-anthrone, 9,10-anthraquinone, 2-ethyl-9,10-anthraquinone, 2-t-butyl-9,10-anthraquinone, 2,6-dichloro-9,10-anthraquinone, xanthone, 2-methylxanthone, 2-methoxyxanthone, 2-ethoxyxanthone, thioxanthone, 2,4-diethylthioxanthone, acridone, 10-butyl-2-chloroacridone, benzyl, dibenzylacetone, p-(dimethylamino)phenyl styryl ketone, p-(dimethylamino)phenyl-p-methyl styryl ketone, benzophenone, p-(dimethylamino)benzophenone (or Michler's ketone), p-(diethylamino)benzophenone, benzoanthrone, a benzothiazole compound described in JP-B No. 51-48516, and TINUVIN 1130 and TINUVIN 400.

Other known photopolymerization initiators than such photopolymerization initiators as described above may be used in the negative dye-containing curable composition of the present invention.

Specific examples thereof include a vicinal polyketaldonyl compound described in U.S. Pat. No. 2,367,660, α-carbonyl compounds described in U.S. Pat. Nos. 2,367,661 and 2,367,670, an acyloin ether described in U.S. Pat. No. 2,448,828, an aromatic acyloin compound substituted with an α-hydrocarbon described in U.S. Pat. No. 2,722,512, a multinuclear quinone compound described in U.S. Pat. Nos. 3,046, 127 and 2,951,758, a combination of a triaryllimidazole dimer and p-aminophenyl ketone described in U.S. Pat. No. 3,549,367, and a benzothiazole compound/ trihalomethyl-s-triazine compound described in JP-B No. 51-48516.

Total amount of the photopolymerization initiators(including the known photopolymerization initiators if they are used) to be used is preferably 0.01 mass % ˜50 mass %, and more preferably 1 mass % ˜30 mass %, and still more preferably 1 mass % ˜20 mass % with respect to the solid content (mass) of radical polymerizable monomers from the viewpoint of improvement in the film hardness and rectangular pattern. When the amount is less than 0.01 mass %, polymerization is difficult, and when the amount is greater than 50 mass %, polymerization rate increases, but the molecular weight is lower, and therefore, film strength becomes to be weakened.

(C) Radical-Polymerizable Monomer

Next, the radical-polymerizable monomer (C) will be described. The radical-polymerizable monomer is preferably a compound having at least one addition-polymerizable ethylenic double bond and a boiling point of 100° C. or more under normal pressure. The ethylenic double bond is preferably (metha)acrylates. The negative dye-containing curable composition according to the aspect of the present invention is constituted such that it has a negative by containing the radical-polymerizable monomer, together with a photopolymerization initiator to be described below and the like.

Examples of such radical-polymerizable monomers include monofunctional acrylates or methacrylates such as polyethylene glycol mono(meth)acrylate, polypropylene glycol mono(meth)acryl ate, and phenoxyethyl (meth)acrylate; polyethylene glycol di(meth)acrylate, trimethylolethane tri(meth)acrylate, neopentylglycol di(meth)acrylate, pentaerythritol tri(meth)acrylate, pentaerythritol tetra(meth)acrylate, dipentaerythritol penta(meth)acrylate, dipentaerythritol hexa(meth) acrylate, hexanediol (meth)acrylate,

trimethylolpropane tri(acryloyloxypropyl)ether, tri(acryloyloxyethyl)isocyanulate; (meth)acrylate compounds prepared after an addition reaction of ethylene oxide or propylene oxide to polyfunctional alcohols such as glycerine and trimethylolethane; urethane acrylates as described in JP-B Nos. 48-41708 and 50-6034, and JP-A No. 51-37193; polyester acrylates as described in JP-A No. 48-64183 and JP-B Nos. 49-43191 and 52-30490; a polyfunctional acrylate or methacrylate such as an epoxyacrylate which is a reaction product of an epoxy resin and (meth)acrylic acid; and mixtures thereof. Examples of the radical-polymerizable monomers further include compounds as described in Nihon Secchaku Kyokaishi (Journal of the Adhesion Society of Japan) Vol. 20, No. 7, pp. 300 to 308 as a photocurable monomer and oligomer. Among these, the multifunctional (meth)acryl compounds is preferred as the radical polymerizable monomer.

The radical polymerizable monomer in the negative dye-containing curable composition is preferably in a range of 1 mass % ˜60 mass % with respect to the solid content of the composition from the viewpoint of curability, and more preferably 10 mass % ˜50 mass %. When the amount is lower that 1 mass %, curability of the exposed portion is insufficient, and when the amount is greater than 60 mass %, leak out of the unexposed portion is significantly lowered.

(X) Inorganic Metal Salt

Hereinafier, an inorganic metal salt (X) (hereinafter, referred to as “inorganic metal salt”) that is different from the organic solvent-soluble dye (A), which is characterized by the invention, will be explained. The expression “inorganic metal salt (X) that is different from the organic solvent-soluble dye (A)” means inorganic metal salts that are not the organic solvent-soluble dye components, and specifically, includes inorganic metal salts or free metallic ions which do not contain salts of the organic solvent-soluble dye.

The negative dye-containing curable composition according to the aspect of the invention comprises the inorganic metal salt in a range of 0.1 mass % or less with respect to the solid content of the composition. The amount of the inorganic metal salt contained in the composition is capable of improving preservation stability, and increasing light fastness. When the amount of the inorganic metal salt exceeds the range of 0.1 mass %, it causes to lower of the preservation stability and the light fastness.

The content of the inorganic metal salt in the negative dye-containing curable composition may be calculated by a method described in JP-A No. 2004-315729.

Specifically, the content may be measured by an on-column derivatization method through a reversed-phase partition chromatography of a metal-sarcosine complex.

As the sarcosine derivatives, for example, a sodium N-(dithiocarboxy)-sarcosine (DTCSNa) manufactured by DOJIN DO LABORATORIES may be used. Further, as a high performance liquid chromatograph, 10 Avp series (manufactured by Shimadzu Corporation) with a column “Octadecyl-2PW” (manufactured by TOSOH COPORATION) of 6.0×150 mm may be used. When measuring the concentration of copper ion (Cu²⁺) by the on-column derivatization method, the concentration of copper ion may be calculated by calibration curve prepared separately from the detected area.

Further, forming a complex of sarcoine derivatives and copper salts is disclosed specifically in “Analytical Chemistry” by Yukio SAKAI and Kazuko KUROKI, 28, 1979, pp 429˜431. Further, confirmation of the metallic complex by a high performance liquid chromatography is described specifically in “Analytical Chemistry” by Seiza, Norimitus TAKAHASHI, Sadanobu INOUE, and Mutsuya MATSUBARA, 35, 1986, pp 819˜822; “Analytical Chemistry” by Shukuro IGARASHI, Akira OBARA, Hiroaki ADACHI, and Takao YOTSUYANAGI, 35, 1986, pp 829˜831; and “Analytical Chemistry” by Eisaburo WATANABE, Hidemitsu NAKAJIMA, Takeshi EBINA, Hitoshi HOSHINO, and Takao YOTSUYANAGI, 32, 1983, pp 469˜474.

As described above, the inorganic metal salt is an inorganic metal salt or a free metallic ion which has no salts of the organic solvent-soluble dyes. The inorganic metal salt having no salts of the organic solvent-soluble dyes is not particularly limited, and examples thereof include chloride salts, acetate salts, sulfate salts, nitrate salts, and hydroxide salts of the following metallic ions. The metallic ions are not particularly limited, and examples thereof include zinc, magnessium, silicon, tin, rodium, platinum, palladium, molibdenum, manganese, lead, copper, nickel, cobalt, iron, titan oxy, vanadium oxy, barium, calcium, sodium, strontium, and the like. As counter ions of these metallic ions, anions derived from synthesis of the respective starting materials.

The inorganic metal salts of the metallic ions are generally derived from their starting materials. Especially, these metallic ions are components produced by reaction catalyst at the time of synthesis of the starting materials, excess at the time of forming metallic complex, excess or release at the time of preparing metallic complex dyes, and the like.

From the viewpoints of preservation stability and light fastness of the negative dye-containing curable composition, calcium and sodium used for the synthesis, or metallic salts that are impurities from the metal containing dyes become problem. Also, when copper phthalocyanine, zinc phthalocyanine, cobalt phthalocyanine, and the like are used, copper, zinc, cobalt ion in a free become respectively problem for the properties mentioned above.

In the negative dye-containing curable composition according to the aspect of the invention, upper limit for the content of the inorganic metal salt is 0.1 mass %, and preferably 0.01 mass % or less with respect to the solid content of the composition. Further, lower limit for the content of the inorganic metal salt is preferably 0, and substantially 0.0001˜0.1 mass %, and preferably, 0.0001˜0.01 mass % with respect to the solid content of the composition. In order to set the content of the inorganic metal salt in the negative dye-containing curable composition within the range defined above, it is preferable to strength the purification of the respective components constituting the composition at the time of synthesis thereof. The strengthening of purification may be performed by removing calcium salt or sodium salt by reinforcement of water washing, by removing free copper, zinc, and cobalt with acid treatment (for example, hydrochloric acid treatment) in a process of after-treatment at the time of synthesis of copper phthalocyanine, zinc phthalocyanine, cobalt phthalocyanine, and the like.

(D) Organic Solvent

The organic solvent (D) is fundamentally not particularly limited, so long as it satisfies solubility of each component and coating ability of the negative dye-containing curable composition. The organic solvent is preferably selected by taking into consideration particularly solubility of the dye and binder, coating ability and safety.

Preferred examples of the organic solvent include an alkyl ester compound, such as ethyl acetate, n-butyl acetate, isobutyl acetate, amyl formate, isoamyl acetate, butyl propionate, isopropyl butyrate, ethyl butyrate, butyl butyrate, methyl lactate, ethyl lactate, methyl oxyacetate, ethyl oxyacetate, butyl oxyacetate, methyl methoxyacetate, ethyl methoxyacetate, butyl methoxyacetate, methyl ethoxyacetate and ethyl ethoxyacetate;

3-oxypropionic acid alkyl ester, such as methyl 3-oxypropionate and ethyl 3-oxypropionate, for example, methyl 3-methoxypropionate, ethyl 3-methoxypropionate, methyl 3-ethoxypropionate and ethyl 3-ethoxypropionate; a 2-oxypropionic acid alkyl ester, such as methyl 2-oxypropionate, ethyl 2-oxypropionate and propyl 2-oxypropionate, for example, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate and ethyl 2-ethoxy-2-methylpropionate; methyl pyruvate, ethyl pyruvate, propyl pyruvate, methyl acetoacetate, ethyl acetoacetate, methyl 2-oxobutanoate and ethyl 2-oxobutanoate;

an ether compound such as diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl ether acetate and propylene glycol monopropyl ether acetate;

a ketone compound, such as methyl ethyl ketone, cyclohexanone, 2-heptanone and 3-heptanone, and an aromatic hydrocarbon compound, such as toluene and xylene.

(E) Binder Resin

Hereinafter, a binder resin (E) will be described. The binder resin in the present invention is not particularly limited, so long as it is soluble in an organic solvent, for example, an organic polymer may be preferably used. Among these, an alkali-soluble binder may be preferably used. The alkali-soluble binder is not particularly limited, so long as it is soluble in water or alkaline solution, but the alkali-soluble binder is selected from the viewpoints of heat resistance, development ability, availability and the like.

The alkali-soluble binder is preferably a linear organic polymer that is soluble in an organic solvent and developable with a weak alkaline aqueous solution. Examples of the linear organic polymer include a polymer having a carboxylic acid on a side chain, such as a methacrylic copolymer, an acrylic copolymer, an itaconic copolymer, a crotonic copolymer, a maleic copolymer and a partially esterified maleic copolymer, described, for example, in JP-A No. 59-44615, JP-B Nos. 54-34327, 58-12577 and 54-25957, and JP-A Nos. 59-53836 and 59-71048, and also, an acidic cellulose derivative having a carboxylic acid on a side chain is useful.

Further, an adduct of an acid anhydride and a polymer having a hydroxyl group, a polyhydroxystyrene resin, a polysiloxane resin, poly(2-hydroxyethyl (meth)acrylate), polyvinylpyrrolidone, polyethyleneoxide and polyvinyl alcohol are also useful.

A monomer having a hydrophilic group may be copolymerized, and examples thereof include alkoxyalkyl (meth)acrylate, hydroxyalkyl (meth)acrylate, glycerol (meth)acrylate, (meth)acrylamide, N-methylolacrylamide, secondary or tertiary alkylacrylamide, dialkylaminoalkyl (meth)acrylate, morpholine (meth)acrylate, N-vinylpyrrolidone, N-vinylcaprolactam, vinylimidazole, vinyltriazole, methyl (meth)acrylate, ethyl (meth)acrylate, branched or linear propyl (meth)acrylate, branched or linear butyl (meth)acrylate and phenoxyhydroxypropyl (meth)acrylate.

Furthermore, a monomer having a tetrahydrofurfuryl group, phosphoric acid, a phosphate ester, a quaternary ammonium salt, an ethyleneoxy chain, a propyleneoxy chain, sulfonic acid or a salt thereof, or a morpholinoethyl group is also useful as the monomer having a hydrophilic group.

Further, in order to improve a cross-linking efficiency, the alkali-soluble binder may have a polymerizable group on a side chain, and a polymer having an allyl group, a (meth)acrylic group or an allyloxy alkyl group on a side chain or the like is also useful as the alkali-soluble binder. Examples of such polymers each having the polymerizable group include KS Resist-106 (trade name; manufactured by Osaka Organic Chemical Industry Ltd.) and Cyclomer P Series (trade name; manufactured by Daicel Chemical Industries, Ltd.). Still further, in order to increase strength of a cured film, alcohol-soluble nylon, a polyether of 2,2-bis-(4-hydroxyphenyl)-propane and epichlorohydrin and the like are also useful as the alkali-soluble binder.

Among various kinds of the alkali-soluble binders, a polyhydroxystyrene resin, a polysiloxane resin, an acrylic resin, an acrylamide resin and an acrylic/acrylamide copolymer resin are preferred from the standpoint of heat resistance, and an acrylic resin, an acrylamide resin and an acrylic/acrylamide copolymer resin are preferred from the standpoint of controllability of developing property.

Preferable examples of such acrylic resins as described above include a copolymer comprising a monomer selected from benzyl (meth)acrylate, (meth)acrylic acid, hydroxyethyl (meth)acrylate and (meth)acrylamide, as well as KS Resist-106 (trade name; manufactured by Osaka Organic Chemical Industry Ltd.) and Cyclomer P series (Daicel Chemical Industries, Ltd.).

The alkali-soluble binder is preferably a polymer having a weight average molecular weight (a value in terms of polystyrene measured by using a GPC method) in the range of from 1000 to 2×10⁵, more preferably in the range of from 2000 to 1×10⁵ and, particularly preferably, in the range of from 5000 to 5×10⁴.

The binder resin is not an essential component, but may be added for the purpose of improving film surface. Amount of the binder resin to be added is preferably 1 mass % ˜40 mass %, and more preferably 1 mass % ˜30 mass % with respect to the solid content of the composition. When the amount becomes less than 1 mass %, uniformity of the coated surface may be impaired. Also, when the amount becomes greater than 40 mass %, suppression of leak out on the exposed portion may be noticeably lowered.

(Other Components)

Cross-Linking Agent

In an embodiment of the present invention, it is possible to obtain a film, which has highly been cured by complementally using a cross-linking agent if necessary. The cross-linking agent will be described below.

The cross-linking agent to be used in the present invention is not particularly limited, so long as it can cure a film by a cross-linking reaction, and examples of such cross-linking agents include (a) an epoxy resin; (b) a melamine compound, a guanamine compound, a glycoluril compound or a urea compound substituted with at least one substituent selected from a methylol group, an alkoxymethyl group and an acyloxymethyl group; and (c) a phenol compound, a naphthol compound or a hydroxyanthrathene compound substituted with at least one substituent selected from a methylol group, an alkoxymethyl group and an acyloxymethyl group. Among these cross-linking agents, a multifunctional epoxy resin is particularly preferred.

The epoxy resin (a) may be any compounds that have an epoxy group and crosslinking property, and examples thereof include a divalent glycidyl group-containing low molecular weight compound, such as bisphenol A diglycidyl ether, ethylene glycol diglycidyl ether, butanediol diglycidyl ether, hexanediol diglycidyl ether, dihydroxybiphenyl diglycidyl ether, diglycidyl phthalate and N,N-diglycidylaniline, a trivalent glycidyl group-containing low molecular weight compound, such as trimethylolpropane triglycidyl ether, trimethylolphenol triglycidyl ether and TrisP-PA triglycidyl ether, a tetravalent glycidyl group-containing low molecular weight compound, such as pentaerythritol tetraglycidyl ether and tetramethylolbisphenol A tetraglycidyl ether, a polyvalent glycidyl group-containing low molecular weight compound, such as dipentaerythritol pentaglycidyl ether and dipentaerythritol hexaglycidyl ether, and a glycidyl group-containing polymer compound, such as polyglycidyl (meth)acrylate and a 1,2-epoxy-4-(2-oxiranyl)cyclohexane adduct of 2,2-bis(hydroxymethyl)-1-butanol.

The number of a methylol group, an alkoxymethyl group and an acyloxymethyl group contained in and substituted on the crosslinking agent (b) is generally from 2 to 6 in the case of the melamine compound and from 2 to 4 in the case of the glycoluril compound, the guanamine compound and the urea compound, and is preferably from 5 to 6 in the case of the melamine compound and from 3 to 4 in the case of the glycoluril compound, the guanamine compound and the urea compound.

Hereinafter, such melamine compound, guanamine compound, glycoluril compound and urea compound as described in (b) may sometimes be referred to also as a methylol group-containing compound of the category (b), an alkoxymethyl group-containing compound of the category (b) or an acyloxymethyl group-containing compound of the category (b).

The methylol group-containing compound of the category (b) may be obtained by heating an alkoxymethyl group-containing compound of the category (b) in an alcohol in the presence of an acid catalyst, such as hydrochloric acid, sulfuric acid, nitric acid and methanesulfonic acid. The acyloxymethyl group-containing compound of the category (b) may be obtained by mixing and stirring a methylol group-containing compound of the category (b) with an acyl chloride in the presence of a basic catalyst.

Specific examples of the compounds of the category (b) having the aforementioned substituent are shown below.

Examples of the melamine compound include hexamethylolmelamine, hexamethoxymethylmelamine, a compound obtained by methoxymethylating from 1 to 5 methylol groups of hexamethylolmelamine or a mixture thereof, hexamethoxyethylmelamine, hexaacyloxymethylmelamine, and a compound obtained by acyloxymethylating from 1 to 5 methylol groups of hexamethylolmelamine or a mixture thereof.

Examples of the guanamine compound include tetramethylolguanamine, tetramethoxymethylguanamine, a compound obtained by methoxymethylating from 1 to 3 methylol groups of tetramethylolguanamine or a mixture thereof, tetramethoxyethylguanamine, tetraacyloxymethylguanamine, and a compound obtained by acyloxymethylating from 1 to 3 methylol groups of tetramethylolguanamine or a mixture thereof.

Examples of the glycoluril compound include tetramethylolglycoluril, tetramethoxymethylglycoluril, a compound obtained by methoxymethylating from 1 to 3 methylol groups of tetramethylolglycoluril or a mixture thereof, and a compound obtained by acyloxymethylating from 1 to 3 methylol groups of tetramethylolglycoluril or a mixture thereof.

Examples of the urea compound include tetramethylolurea, tetramethoxymethylurea, a compound obtained by methoxymethylating from 1 to 3 methylol groups of tetramethylolurea or a mixture thereof, and tetramethoxyethylurea.

The compounds of the category (b) may be used alone or in combinations of 2 or more types.

The cross-linking agent as described in (c), that is, a phenol compound, a naphthol compound or a hydroxyanthracene compound substituted with at least one group selected from a methylol group, an alkoxymethyl group and an acyloxymethyl group can suppress inter-mixing with a overcoat resist by forming cross-links by heating in a same manner as in (b) and further enhance film strength. Hereinafter, such compounds as described above may sometimes be referred to also as a methylol group-containing compound of the category (c), an alkoxymethyl group-containing compound of the category (c) or an acyloxymethyl group-containing compound of the category (c), respectively.

At least two methylol groups, acyloxymethyl groups or alkoxymethyl groups should be contained per one molecule of the cross-linking agent (c). Compounds in which both the 2-position and 4-position of the phenol skeleton are substituted are preferable from the viewpoints of cross-linking ability by heating and preservation stability. Compounds in which both the ortho-position and para-position relative to the OH group of the naphthol or hydroxyanthracene skeleton are substituted are also preferable. The 3-position or 5-position of the phenol compound may be either substituted or unsubstituted.

The naphthol compound may be either substituted or unsubstituted at the positions except for the ortho-position relative to the OH group.

The methylol group-containing compound of the category (c) may be obtained by using a compound having a hydrogen atom at the 2- or 4-position relative to the phenolic OH group as a starting material and, then, allowing the material to react with formalin in the presence of a basic catalyst such as sodium hydroxide, potassium hydroxide, ammonia or tetraalkylammonium hydroxide.

The alkoxymethyl group-containing compound of the category (c) may be obtained by heating the methylol group-containing compound of the category (c) in an alcohol in the presence of an acid catalyst such as hydrochloric acid, sulfuric acid, nitric acid or methane sulfonic acid.

The acyloxymethyl group-containing compound of the category (c) may be obtained by allowing the methylol group-containing compound of the category (c) to react with an acyl chloride in the presence of a basic catalyst.

Examples of the skeleton compound in the crosslinking agent (c) include a phenol compound, a naphthol compound and a hydroxyanthracene compound, in which the o-positions and the p-positions of the phenolic hydroxyl group are unsubstituted, and examples thereof include phenol, isomers of cresol, 2,3-xylenol, 2,5-xylenol, 3,4-xylenol, 3,5-xylenol, a bisphenol compound, such as bisphenol A, 4,4′-bishydroxybiphenyl, TrisP-PA (produced by Honshu Chemical Industry Co., Ltd.), naphthol, dihydroxynaphthalene and 2,7-dihydroxyanthracene.

The specific examples of the crosslinking agent (c) include phenol compounds such as trimethylolphenol, tri(methoxymethyl)phenol, a compound obtained by methoxymethylating from 1 to 2 methylol groups of trimethylolphenol, trimethylol-3-cresol, tri(methoxymethyl)-3-cresol, a compound obtained by methoxymethylating from 1 to 2 methylol groups of trimethylol-3-cresol, a dimethylolcresol, such as 2,6-dimethylol-4-cresol, tetramethylolbisophenol A, tetramethoxymethylbisphenol A, a compound obtained by methoxymethylating from 1 to 3 methylol groups of tetramethylolbisphenol A, tetramethylol-4,4′-bishydroxybphenyl, tetramethoxymethyl-4,4′-bishydroxybiphenyl, a hexamethylol compound of TrisP-PA, a hexamethoxymethyl compound of TrisP-PA, a compound obtained by methoxymethylating from 1 to 5 methylol groups of a hexamethylol compound of TrisP-PA, and bishydroxymethylnaphthalenediol.

Examples of the hydroxyanthracene compound include 1,6-dihydroxymethyl-2,7-dihydroxyanthracene, and examples of the acyloxymethyl group-containing compound include compounds obtained by acyloxymethylating a part or all of the methylol groups of the methylol group-containing compounds.

Among these, trimethylol phenol, bis hydroxymethyl-p-cresol, tetramethylol bisphenol A, and a hexamethylol compound of TrisP-PA (manufactured by Honshu Chemical Industry Co., Ltd.) or a phenol compound in which methylol groups thereof are substituted with alkoxymethyl groups or another phenol compound in which methylol groups thereof are substituted with both methylol groups and alkoxymethyl groups.

The compounds of the category (c) may be used alone or in combinations.

Although total content of the cross-linking agent to be used in the negative dye-containing curable composition depends on types of starting materials, from the standpoints of curability and spectroscopic characterization of the coated film, it is, based on the total solid content (mass) of the composition, preferably in the range of from 1 to 70 mass %, and more preferably in the range of from 5 to 50 mass % and, particularly preferably in the range of from 7 to 30 mass %.

Thermal Polymerization Inhibitor

The negative dye-containing curable composition of the present invention may comprise a thermal polymerization inhibitor in addition to the aforementioned components. Examples of teh thermal polymerization inhibitor include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol) and 2-mercaptobezimidazole as the thermal polymerization inhibitor.

-Various Additives-

In the negative dye-containing curable composition according to the aspect of the present invention, various additives such as a filler, polymer other than those described above, a surfactant, an adhesion accelerating agent, an antioxidant, an ultraviolet ray absorbing agent and an aggregation preventing agent may be used, if necessary.

Examples of the additives include a filler, such as glass and alumina; a polymer other than the binder resin, such as polyvinyl alcohol, polyacrylic acid, polyethylene glycol monoalkyl ether and polyfluoroalkyl acrylate; a surfactant, such as a nonionic surfactant, a cationic surfactant and an anionic surfactant; an adhesion accelerating agent, such as vinyltrimethoxysilane, vinyltriethoxysilane, vinyltris(2-methoxyethoxy)silane, N-(2-amonoethyl)-3-aminopropylmethyldimethoxysilane, N-(2-aminoethyl)-3-aminopropyltrimethyoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane and 3-mercaptopropyltrimethoxysilane; an antioxidant, such as 2,2-thiobis(4-methyl-6-t-butylphenol) and 2,6-di-t-butylphenol; an ultraviolet ray absorbing agent, such as 2-(3-t-butyl-5-methyl-2-hydroxyphenyl)-5-chlorobenzotriazole and alkoxybenzophenone; and an aggregation preventing agent, such as sodium polyacrylate.

In order to accelerate the dissolution of the non-image area to an alkaline solution to attain further improvement of the developing property of the dye-containing curable composition according to the aspect of the present invention, an organic carboxylic acid, preferably a low molecular weight organic carboxylic acid having a molecular weight of 1,000 or less, may be added to the composition. Specific examples thereof include an aliphatic monocarboxylic acid, such as formic acid, acetic acid, propionic acid, butyric acid, valeric acid, pivalic acid, caproic acid, diethylacetic acid, enanthic acid and caprylic acid; an aliphatic dicarboxylic acid, such as oxalic acid, malonic acid, succinic acid, glutaric acid, adipic acid, pimelic acid, suberic acid, azelaic acid, sebacic acid, brassylic acid, methylmalonic acid, ethylmalonic acid, dimethylmalonic acid, methylsuccinic acid, tetramethylsuccinic acid and citraconic acid; an aliphatic tricarboxylic acid, such as tricarballylic acid, aconitic acid and camphoronic acid; an aromatic monocarboxylic acid, such as benzoic acid, toluic acid, cuminic acid, hemellitic acid and mesitylenic acid; an aromatic polycarboxylic acid, such as phthalic acid, isophthalic acid, terephthalic acid, trimellitic acid, trimesic acid, mellophanic acid and pyromellitic acid; and other carboxylic acids, such as phenylacetic acid, hydratropic acid, hydrocinnamic acid, mandelic acid, phenylsuccinic acid, atropic acid, cinnamic acid, methyl cinnamate, benzyl cinnamate, cinnamylideneacetic acid, coumaric acid and umbellic acid.

(Color Filter and Production Method Thereof)

The color filter of the present invention will be described in detail with reference to the production process thereof.

In a method for producing a color filter according to the aspect of the present invention, a color filter may be produced by using the negative dye-containing curable composition as described above.

The negative dye-containing curable composition is coated onto a substrate, which is then exposed through a prescribed mask pattern, followed by being developed with a developer, to form a pattern. In the method for producing a color filter, when producing a color filter having desired colors, the above process is repeated according to the number of colors. The process may further contain, depending on necessity, curing the patterned image by heating and/or exposing. That is, the negative dye-containing curable composition is coated onto a substrate by a coating method, such as spin coating, flow coating and roll coating, to form a radiation sensitive composition layer, which is then exposed through a prescribed mask pattern, followed by being developed with a developer, to form a negative colored pattern (image forming step). The process may further contain, depending on necessity, curing the patterned image by heating and/or exposing.

The color filter comprising desired hues may be produced by repeating the aforementioned image forming steps (and curing step, if necessary) according to the number of the colors. As for light or radiation to be used, ultraviolet light, such as, particularly, g ray, h ray, i ray or the like is favorably used.

Examples of the substrate include soda glass, PYREX™ (R) glass and quartz glass, and those having a transparent electroconductive film adhered, which are used in a liquid crystal display device or the like, and a photoelectric conversion element substrate, such as a silicon substrate, and a complementary metallic oxide semiconductor (CMOS), which are used in a solid state image sensing device, and the like. There are some cases where black stripes for separating pixels are formed on the substrate.

An undercoating layer may be provided, depending on necessity, on the substrate for improvement of adhesion to the upper layer, prevention of diffusion of substances, and planarization of the surface of the substrate.

The developer may be any one that has such a formulation that dissolves an uncured part of the dye-containing curable composition according to the aspect of the present invention but does not dissolve a cured part thereof. Specific examples of the developer include a combination of various organic solvents and an alkaline aqueous solution. Examples of the organic solvent include those described for preparation of the negative dye-containing curable composition according to the aspect of the present invention.

Preferred examples of the alkaline aqueous solution include alkaline aqueous solutions obtained by dissolving an alkaline compound to a concentration of 0.001 to 10% by mass, and preferably from 0.01 to 1% by mass, and examples of the alkaline compound include sodium hydroxide, potassium hydroxide, sodium carbonate,-sodium silicate, sodium metasilicate, aqueous ammonia, ethylamine, diethylamine, dimethylethanolamine, tetramethylammonium hydroxide, tetraethylammonium hydroxide, choline, pyrrole, piperidine and 1,8-diazabicyclo-(5.4.0)-7-undecene. In the case where a developer containing the alkaline aqueous solution is used, the layer thus developed is generally washed with water.

The color filter according to the aspect of the present invention may be used in a liquid crystal display (LCD) or a solid state image pick-up element such as CCD or CMOS. The color filter is suitable for a high resolution CCD element or CMOS having 1,000,000 or more pixels. The color filter may be used by being interposed between light-receiving portions of the pixels constituting the CCD and micro-lenses for converging light.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### EXAMPLES

The present invention is described in detail with reference to examples, but the invention is not limited thereto. Further, all “parts” as used in the examples are by mass, unless otherwise stated.

1) Preparation of the Negative Dye-Containing Curable Composition

Each compound is mixed and dissolved according to the following composition to prepare a negative dye-containing curable composition in each of examples and comparative examples. The amount of metallic ion (Cu²⁺) in the examples was measured as follows: Copper phthalocyanine was determined by a HPLC method using sodium N-(dithiocarboxy)sarcosine salt according to a method described in JP-A No. 2004-315729 and the value obtained is expressed as mass % in a resist solution.

TABLE 1

| | | radical | | | | |
|---|---|---|---|---|---|---|
| | alkali-soluble | polymerizable | organic solvent-soluble | photopolymerization | organic | metallic ion |
| | binder | monomer | dye | initiator | solvent | (Cu²⁺) mass % |
| Example 1 | resin A | monomer A | copper phthalocyanine A | oxime A | cyclohexane | 0.09 |
| | (2.1 g) | (10.4 g) | (6.0 g) | (1.0 g) | (80 g) | |
| Example 2 | resin A | monomer A | copper phthalocyanine A | oxime B | cyclohexane | 0.008 |
| | (2.1 g) | (10.4 g) | (2.0 g) | (1.0 g) | (80 g) | |
| | | | Valifast Yellow 1101 | | | |
| | | | (2.0 g) | | | |
| Example 3 | — | monomer A | copper phthalocyanine A | oxime A | cyclohexane | 0.003 |
| | | (12.5 g) | (2.0 g) | (1.0 g) | (80 g) | |
| | | | Valifast Yellow 1101 | | | |
| | | | (2.0 g) | | | |
| Comparative | resin A | monomer A | copper phthalocyanine A | oxime A | cyclohexane | 1.2 |
| example 1 | (2.1 g) | (10.4 g) | (6.0 g) | (1.0 g) | (80 g) | |
| Comparative | resin A | monomer A | copper phthalocyanine A | oxime B | cyclohexane | 0.6 |
| example 2 | (2.1 g) | (10.4 g) | (2.0 g) | (1.0 g) | (80 g) | |
| | | | Valifast Yellow 1101 | | | |
| | | | (2.0 g) | | | |
| Comparative | — | monomer A | copper phthalocyanine A | oxime A | cyclohexane | 0.5 |
| example 3 | | (12.5 g) | (2.0 g) | (1.0 g) | (80 g) | |
| | | | Valifast Yellow 1101 | | | |
| | | | (2.0 g) | | | |

The expressions used in the Table 1 are as follows.
Resin A: benzyl methacrylate/methacrylic acid copolymer (=80/20 molar ratio)
Monomer A: DPHA (main component: dipentaerythritol hexaacrylate, manufactured by NIPPON KAYAKU CO., LTD)
Oxime A: 2-(O-benzoyloxime)-1-[4-(phenylthio)phenyl]-1.2-octanedion(manufactured by Ciba Specialty Chemicals)
Oxime B: 1-(O-acetyloxime)-1-[9-ethyl-6-(2-methylbenzoyl)-9H-carbazol-3-yl]ethanone (manufactured by Ciba Specialty Chemicals)
Copper phthalocyanine A (trade name: VB-2620, manufactured by Orient Chemical Industries, Ltd.)

“VB-2620” used in Examples 1 to 3 was obtained by dissolving 100 g of commercialized VB-2620 in 1000 g of an organic solvent (ethyl acetate) and by reprecipitating the resulting solution into an aqueous hydrochloric acid for purification. On the other hand, in Comparative examples 1 to 3, commercialized VB-2620 was used.

2) Preparation of Silicon Wafer Substrate Provided with an Undercoat Layer

A resist solution (trade name: CT-2000L; manufactured by Fuji Film Arch Co., Ltd.) was applied onto a silicon wafer substrate by using a spin coater such that the resultant film has a thickness of 2 μm. After the application, the silicon wafer substrate was dried for one hour at 220° C. to form a cured film (undercoat layer).

3) Evaluation of Preservation Stability

The negative dye-containing curable compositions prepared in the respective examples and comparative examples were preserved for one month at a room temperature immediately after the preparation of the compositions. One month later, each composition was applied onto a silicon wafer substrate provided with a undercoat layer which had been prepared in the above 2) to form a coated film under the same conditions for the respective compositions. Thereafter, thicknesses of the film at 10 points were measured by using a contact film thickness measuring system (trade name: DEKTAK6, manufactured by Veeco Instruments). On the basis of the film thicknesses measured, preservation stability was evaluated according to the following criteria and the results were summarized in Table 2.
A: all thicknesses of the film at 10 points are same
B: the thicknesses of the film are varied
   4) Light Fastness

The negative dye-containing curable compositions prepared in the respective examples and comparative examples were respectively applied onto the silicon wafer substrates provided with the undercoat layer in the above 2) such that the resultant film has a thickness of 1 μm. Then, the coated film obtained was subjected to the irradiation with a xenon light for 20 hours by using a xenon irradiation weather meter (trade name: SX75, manufactured by SUGA TEST INSTRUMENTS Co., Ltd.), and the spectral distribution was measured and ΔE*ab was calculated from color analysis program. The results were summarized in Table 2.

TABLE 2

| | preservation stability of resist | |
|---|---|---|
| | solution | light fastness |
| Example 1 | A | 6.5 |
| Example 2 | A | 5.9 |
| Example 3 | A | 5.5 |
| Comparative | B | 13.2 |
| example 1 | | |
| Comparative | B | 11.9 |
| example 2 | | |
| Comparative | B | 10.8 |
| example 3 | | |

Table 2 confirmed that the negative dye-containing curable compositions of Examples 1 to 3 had superior in applicability and had high preservation stability even after a lapse of one month.

On the contrary, in the negative dye-containing curable compositions of Comparative examples 1 to 3, viscosity thereof were increased over time after one month at the room temperature.

Further, any of the negative dye-containing curable compositions of Examples 1 to 3 had excellent in the light fastness, while all of the negative dye-containing curable compositions of Comparative examples 1 to 3 lacked in the light fastness.

According to the aspect of the present invention, a negative dye-containing curable composition having good light fastness and a color filter using the same may be obtained. Further, the present invention provides a method for producing a color filter, which can produce a superior color filter with a high cost performance, especially a color filter for solid state image pick-up elements.

All publications, patent applications, and technical standards mentioned in this specification are herein incorporated by reference to the same extent as if each individual publication, patent application, or technical standard was specifically and individually indicated to be incorporated by reference.

What is claimed is:

1. A negative dye-containing curable composition, comprising (A) an organic solvent-soluble dye, (B) a photopolymerization initiator, (C) a radical-polymerizable monomer, and (D) an organic solvent, wherein the composition further comprises (X) an inorganic metal salt that is different from the organic solvent-soluble dye (A), and the content of the inorganic metal salt (X) is 0.1 mass % or less with respect to the total solid content of the composition.

2. The negative dye-containing curable composition according to claim 1, wherein the content of the inorganic metal salt (X) is 0.01 mass % or less with respect to the total solid content of the composition.

3. The negative dye-containing curable composition according to claim 1, further comprising (E) a binder resin.

4. The negative dye-containing curable composition according to claim 2, further comprising (E) a binder resin.

5. The negative dye-containing curable composition according to claim 1, wherein the radical-polymerizable monomer (C) comprises at least one additionally polymerizable ethylenic double bond and has a boiling point of 100° C. or above at atmospheric pressure.

6. The negative dye-containing curable composition according to claim 5, wherein the radical-polymerizable monomer (C) is a multifunctional (metha)acryl compound.

7. The negative dye-containing curable composition according to claim 3, wherein the binder resin is an alkali-soluble resin.

8. The negative dye-containing curable composition according to claim 1, wherein the organic solvent-soluble dye is a mixture of two or more dyes whose respective light absorption properties are different.

9. The negative dye-containing curable composition according to claim 1, wherein the photopolymerization initiator (B) is at least one compound selected from the group consisting of actively halogenized compounds such as diazole compounds and triazine compounds; 3-aryl-substituted coumarin compounds; lophine dimers; benzophenone compounds; acetophenone compounds and derivatives thereof; cyclopentadiene-benzene-iron complexes and salts thereof; and oxime compounds.

10. The negative dye-containing curable composition according to claim 9, wherein at least one of the photopolymerization initiators (B) is a triazine or an oxime photopolymerization initiator.

11. A color filter, produced by using a negative dye-containing curable composition comprising (A) an organic solvent-soluble dye, (B) a photopolymerization initiator, (C) a radical-polymerizable monomer, and (D) an organic solvent, wherein the composition further comprises (X) an inorganic metal salt that is different from the organic solvent-soluble dye (A), and the content of the inorganic metal salt (X) is 0.1 mass % or less with respect to the total solid content of the composition.

12. A method of producing a color filter, comprising:
applying a negative dye-containing curable composition comprising (A) an organic solvent-soluble dye, (B) a photopolymerization initiator, (C) a radical-polymerizable monomer, and (D) an organic solvent, wherein the composition further comprises (X) an inorganic metal salt that is different from the organic sovent-soluble dye (A), and the content of the inorganic metal salt (X) is 0.1 mass % or less with respect to the total solid content of the composition, onto a substrate to form a radiation sensitive composition layer;
exposing the applied layer through a mask; and
developing the layer to form a negative colored pattern.

13. The method of producing a color filter according to claim 12, wherein the method further comprises curing the patterned image by heating and/or exposing.

14. The method of producing a color filter according to claim 12, wherein pattern forming is repeated according to the number of colors.

15. The method of producing a color filter according to claim 13, wherein curing is repeated according to the number of colors.
